(19) United States
(12) Patent Application Publication
(10) Pub. No.: US 2008/0233244 A1
(43) Pub. Date: Sep. 25, 2008

(54) ANIMAL FOOD COMPOSITIONS AND TREATS

(75) Inventor: Kristen J. Swenson, West Fork, AR (US)

Correspondence Address: Holly M. Amjad, 4300 Duncan Avenue, St. Louis, MO, 63110, US

(73) Assignee: SOLAE, LLC, St. Louis, MO (US)

(21) Appl. No.: 12/053,975

(22) Filed: Mar. 24, 2008

Related U.S. Application Data
(60) Provisional application No. 60/896,602, filed on Mar. 23, 2007.

(51) Int. Cl. A23K 1/16

(52) U.S. Cl. 426/72

(57) ABSTRACT

The invention provides animal food compositions. In particular, the animal food compositions generally contain a structured plant protein along with other macronutrients and micronutrients formulated in amounts to meet the daily nutritional requirements of the animal.

### CROSS REFERENCE TO RELATED APPLICATIONS

This application claims priority from U.S. Provisional Application Ser. No. 60/896,602 filed on Mar. 23, 2007, which is hereby incorporated by reference in its entirety.

### FIELD OF THE INVENTION

The present invention generally provides animal food compositions. In particular, the animal food compositions generally comprise a structured plant protein along with other macronutrients and micronutrients formulated in amounts to meet the daily nutritional requirements of the animal. The present invention also provides animal treats.

### BACKGROUND OF THE INVENTION

Many animal owners desire to provide a diet high in aesthetic appeal and palatability for their animals with an emphasis on health and wellness. Animal owners have a wide choice of food products within the general class of animal foods: (1) dry foods, (2) semi-moist foods; and (3) moist foods. Each animal food of the particular subdivision differs from the other animal food subdivisions in that different moisture and palatability levels are achieved. Generally speaking, the palatability level increases as the moisture level is increased. Thus, animal owners often will add water and other food materials, i.e., left over table scraps, to dry pet food rations in order to increase its acceptance and palatability.

The addition of vegetable and meat to animal food rations creates increased palatability as well as increased nutrition, but at a dramatic increase in cost.

Thus, there is an unmet need for a nutrient fortified animal food composition that simulates the fibrous structure of real animal meat and mimics texture, taste, and color. Further, an advancing extrusion technology is required that makes it possible to develop inexpensive meat-like food pieces from plant protein materials to produce meat analog compositions that simulate real animal meat. These meat-like or meat analog food pieces may or may not contain animal meat. An finally it is desirable to use these meat analog food pieces to create a nutrient fortified animal food compositions that is a low cost yet high quality alternative to current animal food products.

### SUMMARY OF THE INVENTION

One aspect of the invention provides a companion animal food composition. The companion animal food composition generally comprises a structured protein product, the protein product having protein fibers that are substantially aligned, the structured protein product has from about 45% to about 65% soy protein on a dry matter basis, from about 20% to about 30% wheat gluten on a dry matter basis; from about 10% to about 15% wheat starch on a dry matter basis; and from about 1% to about 5% fiber on a dry matter basis. The composition also generally comprises a fat substance in an amount sufficient to meet the daily nutrient requirements of the companion animal; and at least one nutrient selected from the group consisting of vitamins and minerals in an amount sufficient to meet the daily nutrient requirement of the companion animal.

Yet another aspect of the invention provides a companion animal food composition comprising a structured protein product having protein fibers that are substantially aligned. The composition also generally includes a fat substance in an amount sufficient to meet the daily nutrient requirements of the companion animal; and at least one nutrient selected from the group consisting of vitamins and minerals in an amount sufficient to meet the daily nutrient requirement of the companion animal.

Another aspect of the invention provides an animal food composition comprising a meat analog, such as a structured plant protein product having protein fibers that are substantially aligned and animal meat. The composition also includes a fat substance and at least one nutrient selected from the group consisting of vitamins and minerals.

A further aspect of the invention provides a vegetarian companion animal food composition. The vegetarian composition comprises a structured plant protein product; non-meat based fat substance in an amount sufficient to meet the daily nutrient requirements of the companion animal; and at least one nutrient selected from the group consisting of vitamins and minerals in an amount sufficient to meet the daily nutrient requirement of the companion animal.

Another aspect of the invention provides an organic companion animal food composition. The organic composition comprises a structured plant protein product; a fat substance in an amount sufficient to meet the daily nutrient requirements of the companion animal; at least one nutrient selected from the group consisting of vitamins and minerals in an amount sufficient to meet the daily nutrient requirement of the companion animal; and animal meat.

A further aspect of the invention provides a natural companion animal food composition. The natural composition comprises a structured plant protein product; non-meat based fat substance in an amount sufficient to meet the daily nutrient requirements of the companion animal, an optional meat product; and, at least one nutrient selected from the group consisting of vitamins and minerals in an amount sufficient to meet the daily nutrient requirement of the companion animal.

A further aspect of the invention encompasses pet treat products comprising a structured protein product having protein fibers substantially aligned, an optional animal meat, and other optional ingredients, such as fat, vitamins, minerals, colorants, flavorants, and mixtures thereof.

Other aspects and iterations of the invention are described in more detail herein.

### REFERENCE TO COLOR FIGURES

The application contains at least one photograph executed in color. Copies of this patent application publication with color photographs will be provided by the Office upon request and payment of the necessary fee.

### FIGURE LEGENDS

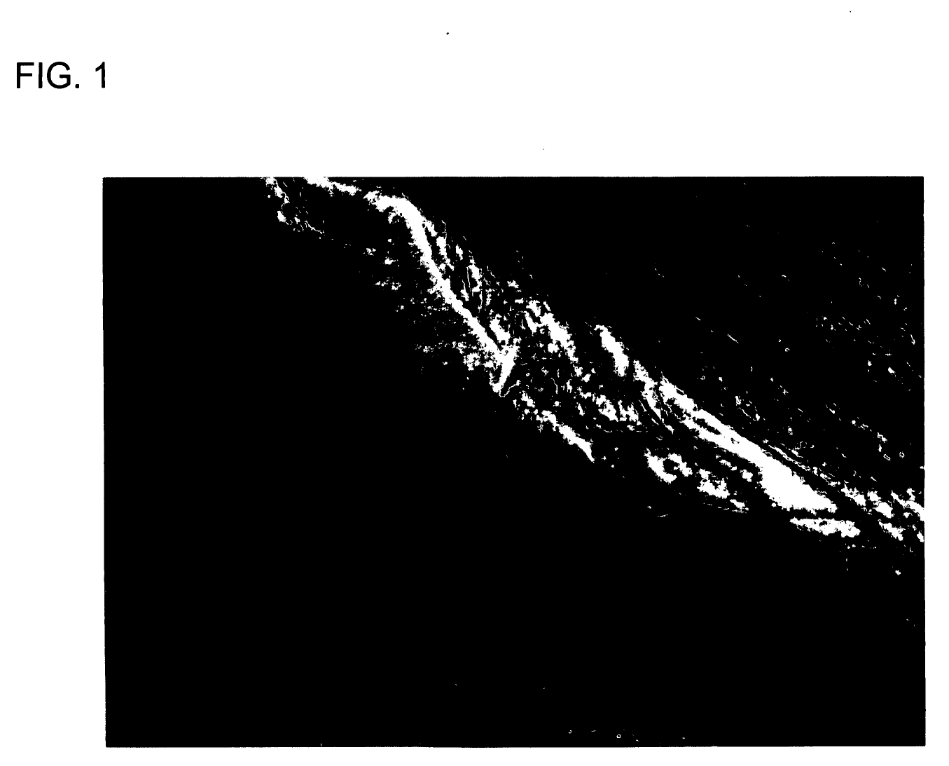

FIG. 1 depicts a photographic image of a micrograph showing a structured plant protein product of the invention having protein fibers that are substantially aligned.

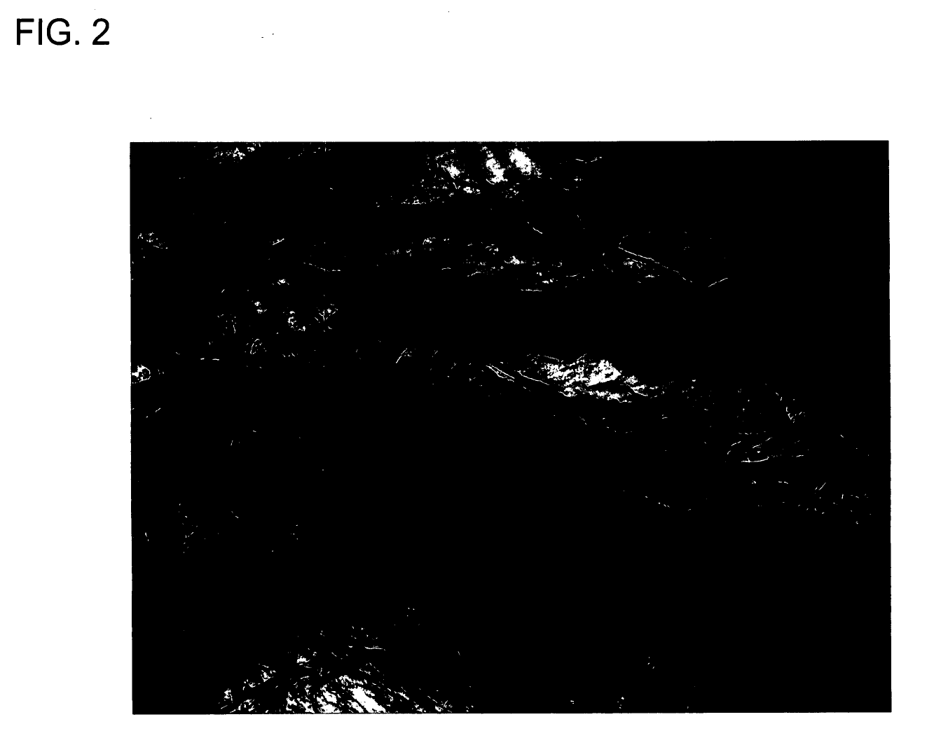

FIG. 2 depicts a photographic image of a micrograph showing a plant protein product not produced by the process of the present invention. The protein fibers comprising the plant protein product, as described herein, are crosshatched.

### DETAILED DESCRIPTION OF THE INVENTION

The present invention provides animal food compositions comprising macronutrients and micronutrients. The macronutrients and micronutrients may be produced organically, naturally, or by conventional, non-organic means. Typically, the animal food composition is a blend of carbohydrates, proteins, fats, fiber, vitamins, and minerals formulated to meet the nutrient requirements of the animal. As one nutrient source, the animal composition will comprise a structured plant product. Another nutrient source is a blend of structured plant product and animal meat. The animal food compositions may advantageously be formulated to meet the nutrient requirements of a variety of animals including ruminants such as cattle, sheep, and goats; aquaculture such as fish and crustaceans; non ruminant livestock such as swine and horses; poultry such as chickens, turkeys, and hatchlings thereof; and companion animals such as dogs and cats. The invention also comprises a variety of animal treats.

### (I) Macronutrients

Macronutrients suitable for use in the animal compositions of the invention include protein, fat, fiber, and carbohydrate formulated to meet the daily nutrient requirements of the animal to which the composition will be fed. Suitable sources of each of these ingredients are detailed below. Organic food compositions are also envisioned. Generally speaking, all of the macronutrient sources detailed below are suitable for use in organic food compositions to the extent the ingredients have been produced in accordance with organic food production techniques generally known in the art, and as the term “organic” is defined herein. Natural food compositions are also envisioned. The animal food composition produced may also be a natural animal food composition to the extent the ingredients have not been produced or subject to a chemically synthetic process and do not containing any additives or processing aids that are chemically synthetic except in amounts as might occur unavoidably in good manufacturing practices. The term “natural” is a general term known in the art, and will be further defined herein.

### (A) Protein

Several sources of protein are suitable for use in the invention. The protein may be derived from an animal source, a plant source, and combinations thereof. In an exemplary embodiment, the protein will comprise a structured plant protein as detailed in section I(A)ii-iii below. In one embodiment the protein source will only come from a plant source in order to produce vegetarian animal food compositions. For vegetarian animal compositions, the protein source will typically be comprised of 100% plant protein. In other embodiments, the vegetarian compositions may include whey protein or albumin protein.

The animal food compositions may have a protein content that varies widely. Typically, the animal food compositions have a protein content from about 1% to about 99% by weight of the composition. More typically, the amount may be from about 1% to about 70% by weight of the composition and even more typically from about 10% to about 50%. For example, the amount of protein may be from about 1% to about 5%, from about 5% to about 10%, from about 10% to about 15%, from about 15% to about 20%, from about 20% to about 25%, from about 25% to about 30%, from about 30% to about 35%, from about 35% to about 40%, from about 40% to about 45%, from about 45% to about 50%, or greater than 50% by weight of the composition.

i. Animal Meat

A variety of animal meats are suitable as a protein source. By way of example, meat and meat ingredients defined specifically for the various structured vegetable protein patents include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water fish such as catfish, tuna, sturgeon, salmon, bass, muskie, pike, bowfin, gar, paddlefish, bream, carp, trout, walleye, snakehead and crappie, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, lamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means) such as mechanically separated beef, mechanically separated pork, mechanically separated fish including surimi, mechanically separated chicken, mechanically separated turkey, any cooked animal flesh and organ meats derived from any animal species. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo, and porcupine as well as reptilian creatures such as snakes, turtles, and lizards should be considered meat.

It is also envisioned that a variety of meat qualities may be utilized in the invention. The meat may comprise muscle tissue, organ tissue, connective tissue, and skin. The meat may be any meat suitable for consumption. The meat may be non-rendered, non-dried, raw meat, raw meat products, raw meat by-products, and mixtures thereof. For example, whole meat muscle that is either ground or in chunk or steak form may be utilized. In another embodiment, the meat may be mechanically deboned or separated raw meats using high-pressure machinery that separates bone from animal tissue, by first crushing bone and adhering animal tissue and then forcing the animal tissue, and not the bone, through a sieve or similar screening device. The process forms an unstructured, paste-like blend of soft animal tissue with a batter-like consistency and is commonly referred to as mechanically deboned meat or MDM. Alternatively, the meat may be a meat by-product. In the context of the present invention, the term “meat by-products” is intended to refer to those non-rendered parts of the carcass of slaughtered animals including but not restricted to mammals, poultry and the like, including such constituents as are embraced by the term “meat by-products” in the Definitions of Feed Ingredients published by the Association of American Feed Control Officials, Incorporated. Examples of meat by-products are organs and tissues such as lungs, spleens, kidneys, brain, liver, blood, bone, partially defatted low-temperature fatty tissues, stomachs, intestines free of their contents, and the like.

ii. Protein-Containing Material

A variety of ingredients that contain protein may be utilized in a thermal plastic extrusion process to produce structured protein products suitable for use in the animal food compositions. While ingredients comprising proteins derived from plants are typically used, it is also envisioned that proteins derived from other sources, such as animal sources, may be utilized without departing from the scope of the invention. It is also envisioned that the protein source may be an animal derived protein other than animal tissue. For example, a dairy protein selected from the group consisting of casein, caseinates, whey protein, and mixtures thereof may be utilized. In an exemplary embodiment, the dairy protein is whey protein. By way of further example, an egg protein selected from the group consisting of ovalbumin, ovoglobulin, ovomucin, ovomucoid, ovotransferrin, ovovitella, ovovitellin, albumin globulin, and vitellin may be utilized. Further, meat proteins or protein ingredients consisting of collagen, blood, organ meat, mechanically separated meat, partially defatted tissue and blood serum proteins may be included as one or more of the ingredients of the structured protein products.

It is envisioned that other ingredient types in addition to proteins may be utilized. Non-limiting examples of such ingredients include sugars, starches, oligosaccharides, soy fiber, other dietary fibers, gluten, and mixtures thereof.

While in some embodiments gluten may be used as a protein, it is also envisioned that the protein-containing starting materials may be gluten-free. Further it is envisioned that the protein-containing starting materials may be wheat free. Because gluten is typically used in filament formation during the extrusion process, if a gluten-free starting material is used, an edible cross-linking agent may be utilized to facilitate filament formation. Non-limiting examples of suitable cross-linking agents include Konjac glucomannan (KGM) flour, BetaGlucan manufactured by Takeda (USA), transglutaminase, calcium salts, and magnesium salts. One skilled in the art can readily determine the amount of cross-linking material needed, if any, in gluten-free embodiments.

Irrespective of its source or ingredient classification, the ingredients utilized in the extrusion process are typically capable of forming extrudates having protein fibers that are substantially aligned. Suitable examples of such ingredients are detailed more fully below.

(iii) Plant Derived Protein

The protein source may be from a plant. Suitable plants from which protein may be derived include legumes, corn, peas, canola, sunflowers, sorghum, rice, amaranth, potato, tapioca, arrowroot, canna, lupin, rape, wheat, oats, rye, barley, and mixtures thereof. In an exemplary embodiment, the protein will comprise structured protein products having protein fibers that are substantially aligned, as described in more detail. In an exemplary embodiment, the structured protein products are extrudates of protein material that have been subjected to the extrusion process detailed below. Because the structured protein products have protein fibers that are substantially aligned in a manner similar to animal meat, the protein compositions of the invention generally have the texture and eating quality characteristics of compositions comprised of one hundred percent animal meat.

Irrespective of its source or ingredient classification, the ingredients utilized in the extrusion process are typically capable of forming extrudates having protein fibers that are substantially aligned. In an exemplary embodiment, at least one ingredient derived from a plant will be utilized to form the protein-containing materials. Generally speaking, the ingredient will comprise a protein. The amount of protein present in the ingredient(s) utilized can and will vary depending upon the application. For example, the amount of protein present in the ingredient(s) utilized may range from about 40% to about 100% by weight. In another embodiment, the amount of protein present in the ingredient(s) utilized may range from about 50% to about 100% by weight. In an additional embodiment, the amount of protein present in the ingredient(s) utilized may range from about 60% to about 100% by weight. In a further embodiment, the amount of protein present in the ingredient(s) utilized may range from about 70% to about 100% by weight. In still another embodiment, the amount of protein present in the ingredient(s) utilized may range from about 80% to about 100% by weight. In a further embodiment, the amount of protein present in the ingredient(s) utilized may range from about 90% to about 100% by weight.

The ingredient(s) utilized in extrusion may be derived from a variety of suitable plants. By way of non-limiting example, suitable plants include legumes, corn, peas, canola, sunflowers, sorghum, rice, amaranth, potato, tapioca, arrowroot, canna, lupin, rape, wheat, oats, rye, barley, and mixtures thereof.

In one embodiment, the ingredient(s) are derived from organically grown plants. By way of non-limiting example, suitable organically grown plants include legumes, corn, peas, canola, kamut, quinoa, sunflowers, sorghum, rice, amaranth, potato, tapioca, arrowroot, canna, lupin, rape, wheat, oats, rye, barley, and mixtures thereof. In another embodiment, the ingredients are isolated from wheat and soybeans. In still another exemplary embodiment, the ingredients are isolated from soybeans. Suitable wheat derived protein-containing ingredients include wheat gluten, wheat flour, and mixtures thereof. Examples of commercially available wheat gluten that may be utilized in the invention include Manildra Gem of the West Gluten Vital Wheat Gluten and Manildra Gem of the West Organic Vital Wheat Gluten each of which is available from Manildra Milling. Suitable soybean derived protein-containing ingredients (“soy protein material”) include soy protein isolate, soy protein concentrate, soy flour, and mixtures thereof, each of which are detailed below. Suitable corn derived protein-containing ingredients include corn gluten meal, for example, zein. In each of the foregoing embodiments, the soy protein material may be combined with one or more ingredients selected from the group consisting of a starch, flour, gluten, a dietary fiber, and mixtures thereof.

Suitable examples of protein-containing material isolated from a variety of sources are detailed in Table A, which shows various combinations.

TABLE A
Protein Combinations

| First protein | |
|---|---|
| ingredient | Second protein ingredient |
| soybean | Wheat |
| soybean | Canola |
| soybean | Corn |
| soybean | Lupin |
| soybean | Oat |
| soybean | Pea |
| soybean | Rice |
| soybean | Sorghum |
| soybean | Amaranth |
| soybean | Arrowroot |
| soybean | Barley |
| soybean | Buckwheat |
| soybean | Cassava |
| soybean | channa (garbanzo) |
| soybean | Millet |
| soybean | Peanut |
| soybean | Potato |
| soybean | Rye |
| soybean | Sunflower |
| soybean | Tapioca |
| soybean | Triticale |
| soybean | Dairy |
| soybean | Whey |
| soybean | Egg |
| soybean | wheat and canola |
| soybean | wheat and corn |
| soybean | wheat and lupin |
| soybean | wheat and oat |
| soybean | wheat and pea |
| soybean | wheat and rice |
| soybean | wheat and sorghum |
| soybean | wheat and amaranth |
| soybean | wheat and arrowroot |
| soybean | wheat and barley |
| soybean | wheat and buckwheat |
| soybean | wheat and cassava |
| soybean | wheat and channa (garbanzo) |
| soybean | wheat and millet |
| soybean | wheat and peanut |
| soybean | wheat and rye |
| soybean | wheat and potato |
| soybean | wheat and sunflower |
| soybean | wheat and tapioca |
| soybean | wheat and triticale |
| soybean | wheat and dairy |
| soybean | wheat and whey |
| soybean | wheat and egg |
| soybean | canola and corn |
| soybean | canola and lupin |
| soybean | canola and oat |
| soybean | canola and pea |
| soybean | canola and rice |
| soybean | canola and sorghum |
| soybean | canola and amaranth |
| soybean | canola and arrowroot |
| soybean | canola and barley |
| soybean | canola and buckwheat |
| soybean | canola and cassava |
| soybean | canola and channa (garbanzo) |
| soybean | canola and millet |
| soybean | canola and peanut |
| soybean | canola and rye |
| soybean | canola and potato |
| soybean | canola and sunflower |
| soybean | canola and tapioca |
| soybean | canola and triticale |
| soybean | canola and dairy |
| soybean | canola and whey |
| soybean | canola and egg |
| soybean | corn and lupin |

In each of the embodiments delineated in Table A, the combination of protein-containing materials may be combined with one or more ingredients selected from the group consisting of a starch, four, gluten, a dietary fiber, and mixtures thereof. In one embodiment, the protein-containing material comprises protein, starch, gluten, and fiber. In an exemplary embodiment, the proteins-containing material comprises from about 45% to about 65% soy protein on a dry matter basis; from about 20% to about 30%; wheat gluten on a dry matter basis; from about 10% to about 15% wheat starch on a dry matter basis; and from about 1% to about 5% fiber on a dry matter basis. In each of the foregoing embodiments, the protein-containing material may comprise dicalcium phosphate, L-cysteine or combinations of both dicalcium phosphate and L-cysteine.

(a) Soy Protein Materials

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybean may be standard soybeans (i.e., non genetically modified soybeans), commoditized soybeans, genetically modified soybeans, and combinations thereof.

Generally speaking, when soy protein isolate is used, an isolate is preferably selected that is not a highly hydrolyzed soy protein isolate. In certain embodiments, highly hydrolyzed soy protein isolates, however, may be used in combination with other soy protein isolates provided that the highly hydrolyzed soy protein isolate content of the combined soy protein isolates is generally less than about 40% of the combined soy protein isolates, by weight. Additionally, the soy protein isolate utilized preferably has an emulsion strength and gel strength sufficient to enable the protein in the isolate to form fibers that are substantially aligned upon extrusion. It is also possible to use membrane filtered soy protein isolates. Examples of soy protein isolates that are useful in the present invention are commercially available, for example, from Solae, LLC (St. Louis, Mo.), and include SUPRO® 500E, SUPRO® EX 33, SUPRO® 620, SUPRO® EX 45, and SUPRO® 595.

Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 55% of the soy protein isolate by weight. The soy protein concentrate can be substituted for up to about 50% of the soy protein isolate by weight. It is also possible in an embodiment to substitute 40% by weight of the soy protein concentrate for the soy protein isolate. In another embodiment, the amount of soy protein concentrate substituted is up to about 30% of the soy protein isolate by weight. Examples of suitable soy protein concentrates useful in the invention include PROCON, ALPHA 12, and ALPHA 5800, which are commercially available from Solae, LLC (St. Louis, Mo.). If soy flour is substituted for a portion of the soy protein isolate, the soy flour is substituted for up to about 35% of the soy protein isolate by weight. The soy flour should be a high protein dispersidility index (PDI) soy flour.

Any fiber known in the art can be used as the fiber source in the application. Soy cotyledon fiber may optionally be utilized as a fiber source. Typically, suitable soy cotyledon fiber will generally effectively bind water when the mixture of soy protein and soy cotyledon fiber is extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. When present in the soy protein material, soy cotyledon fiber may generally be present in the soy protein material in an amount ranging from about 1% to about 20%, preferably from about 1.5% to about 20% and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

(b) Additional Ingredients

A variety of additional ingredients may be added to any of the protein-containing materials detailed above without departing from the scope of the invention. For example, antioxidants, antimicrobial agents, and combinations thereof may be included. Antioxidant additives include BHA, BHT, TBHQ, vitamins A, C and E and derivatives thereof. Additionally, various plant extracts such as those containing carotenoids, tocopherols or flavonoids having antioxidant properties, may be included to increase the shelf life or nutritionally enhance the protein compositions and animal food compositions. The antioxidants and the antimicrobial agents may have a combined presence at levels of from about 0.01% to about 10%, preferably, from about 0.05% to about 5%, and more preferably from about 0.1% to about 2%, by weight of the protein-containing materials.

(c) Moisture Content

As will be appreciated by the skilled artisan, the moisture content of the protein-containing materials and optional additional ingredients can and will vary depending on the thermal process the combination is subjected to e.g. retort cooking, microwave cooking, and extrusion. The water is used to hydrate the ingredients of the protein composition. Generally speaking, the moisture content may range from about 1% to about 80% by weight. In low moisture extrusion applications, the moisture content of the protein-containing materials may range from about 1% to about 35% by weight. Alternatively, in high moisture extrusion applications, the moisture content of the protein-containing materials may range from about 35% to about 80% by weight. In an exemplary embodiment, the extrusion application utilized to form the extrudates is low moisture.

(d) Extrusion of the Protein-Containing Material

A suitable extrusion process for the preparation of structured protein products comprises introducing the protein material, which includes plant protein material and optionally other protein material, and other ingredients into a mixing vessel (i.e., an ingredient blender) to combine the ingredients and form a dry blended protein material pre-mix. The dry blended protein material pre-mix may be transferred to a hopper from which the dry blended ingredients are introduced along with moisture into a pre-conditioner to form a conditioned protein material mixture. The conditioned material is then fed to an extruder in which the mixture is heated under mechanical pressure generated by the screws of the extruder to form a molten extrusion mass. Alternatively, the dry blended protein material pre-mix may be directly fed to an extruder in which moisture and heat are introduced to form a molten extrusion mass. The molten extrusion mass exits the extruder through an extrusion die assembly forming an extrudate comprising structured protein products having protein fibers that are substantially aligned.

(i) Extrusion Process Conditions

Among the suitable extrusion apparatuses useful in the practice of the present invention is a double barrel, twin-screw extruder as described, for example, in U.S. Pat. No. 4,600,311. Further examples of suitable commercially available extrusion apparatuses include a CLEXTRAL® Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety.

A single screw extruder could also be used in the present invention. Examples of suitable, commercially available single-screw extrusion apparatuses include the WENGER Model X-175, the WENGER Model X-165, and the WENGER Model X-85, all of which are available from Wenger Manufacturing, Inc.

The screws of a twin-screw extruder can rotate within the barrel in the same or opposite directions. Rotation of the screws in the same direction is referred to as single flow, whereas rotation of the screws in opposite directions is referred to as double flow or counter rotating. The speed of the screw or screws of the extruder may vary depending on the particular apparatus; however, it is typically from about 250 to about 450 revolutions per minute (rpm). Generally, as the screw speed increases, the density of the extrudate will decrease. The extrusion apparatus contains screws assembled from shafts and worm segments, as well as mixing lobe and ring-type shearlock elements as recommended by the extrusion apparatus manufacturer for extruding plant protein material.

The extrusion apparatus generally comprises a plurality of heating zones through which the protein mixture is conveyed under mechanical pressure prior to exiting the extrusion apparatus through an extrusion die assembly. The temperature in each successive heating zone generally exceeds the temperature of the previous heating zone by between about 10° C. and about 70° C. In one embodiment, the conditioned pre-mix is transferred through four heating zones within the extrusion apparatus, with the protein mixture heated to a temperature of from about 100° C. to about 150° C. such that the molten extrusion mass enters the extrusion die assembly at a temperature of from about 100° C. to about 150° C. One skilled in the art could adjust the temperature either heating or cooling to achieve the desired properties. Typically, temperature changes are due to work input and can happen suddenly.

The pressure within the extruder barrel is typically between about 50 psig to about 500 psig preferably between about 75 psig to about 200 psig. Generally, the pressure within the last two heating zones is from about 100 psig to about 3000 psig preferably between about 150 psig to about 500 psig. The barrel pressure is dependent on numerous factors including, for example, the extruder screw speed, feed rate of the mixture to the barrel, feed rate of water to the barrel, and the viscosity of the molten mass within the barrel.

Water is injected into the extruder barrel to hydrate the plant protein material mixture and promote texturization of the proteins. As an aid in forming the molten extrusion mass, the water may act as a plasticizing agent. Water may be introduced to the extruder barrel via one or more injection jets in communication with a heating zone. Typically, the mixture in the barrel contains from about 15% to about 35% by weight water. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Preferably, from about 0.1 kg to about 1 kg of water per kg of protein are introduced to the barrel.

(ii) Optional Preconditioning

In a pre-conditioner, the protein-containing material and optional additional ingredients (protein-containing mixture) are preheated, contacted with moisture, and held under controlled temperature and pressure conditions to allow the moisture to penetrate and soften the individual particles. The preconditioning step increases the bulk density of the particulate fibrous material mixture and improves its flow characteristics. The preconditioner contains one or more paddles to promote uniform mixing of the protein and transfer of the protein mixture through the preconditioner. The configuration and rotational speed of the paddles vary widely, depending on the capacity of the preconditioner, the extruder throughput and/or the desired residence time of the mixture in the preconditioner or extruder barrel. Generally, the speed of the paddles is from about 100 to about 1300 revolutions per minute (rpm). Agitation must be high enough to obtain even hydration and good mixing.

Typically, the protein-containing mixture is pre-conditioned prior to introduction into the extrusion apparatus by contacting the pre-mix with moisture (i.e., steam and/or water). Preferably the protein-containing mixture is heated to a temperature of from about 25° C. to about 80° C., more preferably from about 30° C. to about 40° C. in the preconditioner using appropriate water temperature.

Typically, the protein-containing pre-mix is conditioned for a period of about 0.5 minutes to about 10 minutes, depending on the speed and the size of the pre-conditioner. In an exemplary embodiment, the protein-containing pre-mix is conditioned for a period of about 3 minutes to about 5 minutes. In a further embodiment, the protein containing pre-mix is conditioned for a period of about 30 to 60 seconds. The pre-mix is contacted with steam and/or water and heated in the pre-conditioner at generally constant steam flow to achieve the desired temperatures. The water and/or steam conditions (i.e., hydrates) the pre-mix, increases its density, and facilitates the flowability of the dried mix without interference prior to introduction to the extruder barrel where the proteins are texturized. If low moisture pre-mix is desired, the conditioned pre-mix may contain from about 1% to about 35% (by weight) water. If high moisture pre-mix is desired, the conditioned pre-mix may contain from about 35% to about 80% (by weight) water.

The conditioned pre-mix typically has a bulk density of from about 0.25 g/cm³ to about 0.60 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel.

(iii) Extrusion Process

The dry pre-mix or the conditioned pre-mix is then fed into an extruder to heat, shear, and ultimately plasticize the mixture. The extruder may be selected from any commercially available extruder and may be a single screw extruder or preferably a twin-screw extruder that mechanically shears the mixture with the screw elements.

Whatever extruder is used, it should be run in excess of about 50% motor load. The rate at which the pre-mix is generally introduced to the extrusion apparatus will vary depending upon the particular apparatus. Typically, the conditioned pre-mix is introduced to the extrusion apparatus at a rate of between about 16 kilograms per minute to about 60 kilograms per minute. In another embodiment, the conditioned pre-mix is introduced to the extrusion apparatus at a rate between 20 kilograms per minute to about 40 kilograms per minute. The conditioned pre-mix is introduced to the extrusion apparatus at a rate of between about 26 kilograms per minute to about 32 kilograms per minute. Generally, it has been observed that the density of the extrudate decreases as the feed rate of pre-mix to the extruder increases.

The pre-mix is subjected to shear and pressure by the extruder to plasticize the mixture. The screw elements of the extruder shear the mixture as well as create pressure in the extruder by forcing the mixture forwards though the extruder and through the die assembly. The screw motor speed determines the amount of shear and pressure applied to the mixture by the screw(s). Preferably, the screw motor speed is set to a speed of from about 200 rpm to about 500 rpm, and more preferably from about 300 rpm to about 450 rpm, which moves the mixture through the extruder at a rate of at least about 20 kilograms per hour, and more preferably at least about 40 kilograms per hour. Preferably the extruder generates an extruder barrel exit pressure of from about 50 to about 3000 psig, and more preferably an extruder barrel exit pressure of from about 600 to about 1000 psig is generated.

The extruder controls the temperature of the mixture as it passes through the extruder further denaturing the protein in the mixture. The extruder includes a means for heating the mixture to temperatures of from about 100° C. to about 180° C. Preferably the means for heating the mixture in the extruder comprises extruder barrel jackets into which heating or cooling media such as steam or water may be introduced to control the temperature of the mixture passing through the extruder. The extruder may also include steam injection ports for directly injecting steam into the mixture within the extruder. The extruder preferably includes multiple heating zones that can be controlled to independent temperatures, where the temperatures of the heating zones are preferably set to increase the temperature of the mixture as it proceeds through the extruder. For example, the extruder may be set in a four temperature zone arrangement, where the first zone (adjacent the extruder inlet port) is set to a temperature of from about 80° C. to about 100° C., the second zone is set to a temperature of from about 100° C. to 135° C., the third zone is set to a temperature of from 135° C. to about 150° C., and the fourth zone (adjacent the extruder exit port) is set to a temperature of from 150° C. to 180° C. The extruder may be set in other temperature zone arrangements, as desired. For example, the extruder may be set in a five temperature zone arrangement, where the first zone is set to a temperature of about 25° C., the second zone is set to a temperature of about 50° C., the third zone is set to a temperature of about 95° C., the fourth zone is set to a temperature of about 130° C., and the fifth zone is set to a temperature of about 150° C.

The mixture forms a melted plasticized mass in the extruder. A die assembly is attached to the extruder in an arrangement that permits the plasticized mixture to flow from the extruder exit port into the die assembly, wherein the die assembly consists of a die and a back plate. The back plate is attached to the inner face of the die for the purpose of directing the flow of material entering the die towards the die aperture(s). Additionally, the die assembly produces substantial alignment of the protein fibers within the plasticized mixture as it flows through the die assembly. The back plate in combination with the die creates a central chamber that receives the melted plasticized mass from the extruder through a central opening. From at least one central chamber, the melted plasticized mass is directed by flow directors into at least one elongated tapered channel. Each elongated tapered channel leads directly to an individual die aperture. The extrudate exits the die through at least one aperture in the periphery or side of the die assembly at which point the protein fibers contained within are substantially aligned. It is also contemplated that the extrudate may exit the die assembly through at least one aperture in the die face, which may be a die plate affixed to the die. The width, height, and thickness dimensions of the die aperture(s) are selected and set prior to extrusion of the mixture to provide the fiberous material extrudate with the desired dimensions.

The width and height dimensions of the die aperture(s) are selected and set prior to extrusion of the mixture to provide the fibrous material extrudate with the desired dimensions. The width of the die aperture(s) may be set so that the extrudate resembles any real meat product desired, such as from a cubic chunk of meat, to a steak filet, to linked meats, or processed meats, where widening the width of the die aperture(s) decreases the cubic chunk-like nature of the extrudate and increases the filet-like nature of the extrudate. Preferably the width of the die aperture(s) is/are set to a width of from about 5 millimeters to about 40 millimeters.

The height dimension of the die aperture(s) may be set to provide the desired thickness of the extrudate. The height of the aperture(s) may be set to provide a very thin extrudate or a thick extrudate. Preferably, the height of the die aperture(s) may be set to from about 1 millimeter to about 30 millimeters, and more preferably from about 8 millimeters to about 16 millimeters.

It is also contemplated that the die aperture(s) may be round. The diameter of the die aperture(s) may be set to provide the desired thickness of the extrudate. The diameter of the aperture(s) may be set to provide a very thin extrudate or a thick extrudate. Preferably, the diameter of the die aperture(s) may be set to from about 1 millimeter to about 30 millimeters, and more preferably from about 8 millimeters to about 16 millimeters.

Examples of peripheral die assemblies suitable for use in this invention to produce the structured protein fibers that are substantially aligned are described in U.S. Pat. App. No. 60/882,662 and U.S. patent application Ser. No. 11/964,538, which are hereby incorporated by reference in their entirety.

The extrudate is cut after exiting the die assembly. Suitable apparatuses for cutting the extrudate include flexible knives manufactured by Wenger Manufacturing, Inc. (Sabetha, Kans.) and Clextral, Inc. (Tampa, Fla.). A delayed cut can also be done to the extrudate. One such example of a delayed cut device is a guillotine device.

A dryer, if one is used, generally comprises a plurality of drying zones in which the air temperature may vary. Examples known in the art include convection dryers. Generally, the temperature of the air within one or more of the zones will be from about 100° C. to about 185° C. Typically, the extrudate is present in the dryer for a time sufficient to provide an extrudate having the desired moisture content. Generally, the extrudate is dried for at least about 5 minutes and more generally, for at least about 10 minutes. Alternatively, the extrudate may be dried at lower temperatures, such as about 50° C., for longer periods of time. Suitable dryers include those manufactured by CPM Wolverine Proctor (Lexington, N.C.), National Drying Machinery Co. (Trevose, Pa.), Wenger (Sabetha, Kans.), Clextral® (Tampa, Fla.), and Buehler (Lake Bluff, Ill.).

Another option is to use microwave assisted drying. In this embodiment, a combination of convective and microwave heating is used to dry the product to the desired moisture. Microwave assisted drying is accomplished by simultaneously using forced-air convective heating and drying to the surface of the product while at the same time exposing the product to microwave heating that forces the moisture that remains in the product to the surface whereby the convective heating and drying continues to dry the product. The convective dryer parameters are the same as discussed previously. The addition is the microwave-heating element, with the power of the microwave being adjusted dependent on the product to be dried as well as the desired final product moisture. As an example the product can be conveyed through an oven that contains a tunnel that is equipped with wave-guides to feed the microwave energy to the product and chokes designed to prevent the microwaves from leaving the oven. As the product is conveyed through the tunnel the convective and microwave heating simultaneously work to lower the moisture content of the product whereby drying. Typically, the air temperature is 50° C. to about 80° C., and the microwave power is varied dependent on the product, the time the product is in the oven, and the final moisture content desired.

The desired moisture content may vary widely depending on the intended application of the extrudate. Generally speaking, the extruded material has a moisture content of from about 5% to about 13% by weight, if dried, and needs to be hydrated in water until the water is absorbed and the fibers are separated. If the protein material is not dried or not fully dried, its moisture content is higher, generally from about 16% to about 30% by weight. If a protein material with high moisture is produced, the protein material may require immediate use or refrigeration to ensure product freshness, and minimize spoilage.

The dried extrudate may further be comminuted to reduce the average particle size of the extrudate. Suitable grinding apparatus include hammer mills such as Mikro Hammer Mills manufactured by Hosokawa Micron Ltd. (England), Fitzmill® manufactured by the Fitzpatrick Company (Elmhurst, Ill.), Comitrol® processors made by Urschel Laboratories, Inc. (Valparaiso, Ind.), and roller mills such as RossKamp Roller Mills manufactured by RossKamp Champion (Waterloo, Ill.).

(e) Characterization of the Structured Protein Products

The extrudates typically comprise the structured protein products having protein fibers that are substantially aligned. In the context of this invention “substantially aligned” generally refers to the arrangement of protein fibers such that a significantly high percentage of the protein fibers forming the structured protein product are contiguous to each other at less than approximately a 45° angle when viewed in a horizontal plane. Typically, an average of at least 55% of the protein fibers comprising the structured protein product are substantially aligned. In another embodiment, an average of at least 60% of the protein fibers comprising the structured protein product are substantially aligned. In a further embodiment, an average of at least 70% of the protein fibers comprising the structured protein product are substantially aligned. In an additional embodiment, an average of at least 80% of the protein fibers comprising the structured protein product are substantially aligned. In yet another embodiment, an average of at least 90% of the protein fibers comprising the structured protein product are substantially aligned. Methods for determining the degree of protein fiber alignment are known in the art and include visual determinations based upon micrographic images.

By way of example, FIGS. 1 and 2 depict micrographic images that illustrate the difference between a structured protein product having substantially aligned protein fibers compared to a protein product having protein fibers that are significantly crosshatched. FIG. 1 depicts a structured protein product prepared according to the extrusion process detailed above having protein fibers that are substantially aligned. Contrastingly, FIG. 2 depicts a protein product containing protein fibers that are significantly crosshatched and not substantially aligned. Because the protein fibers are substantially aligned, as shown in FIG. 1, the structured protein products utilized in the invention generally have the texture and consistency of cooked muscle meat. In contrast, extrudates having protein fibers that are randomly oriented or crosshatched generally have a texture that is soft or spongy.

In addition to having protein fibers that are substantially aligned, the structured protein products also typically have shear strength substantially similar to whole meat muscle. In this context of the invention, the term “shear strength” provides one means to quantify the formation of a sufficient fibrous network to impart whole-muscle like texture and appearance to the structured protein product. Shear strength is the maximum force in grams needed to shear through a given sample. A method for measuring shear strength is described in Example 1.

Generally speaking, the structured protein products of the invention will have average shear strength of at least 1400 grams. In an additional embodiment, the structured protein products will have average shear strength of from about 1500 to about 1800 grams. In yet another embodiment, the structured protein products will have average shear strength of from about 1800 to about 2000 grams. In a further embodiment, the structured protein products will have average shear strength of from about 2000 to about 2600 grams. In an additional embodiment, the structured protein products will have average shear strength of at least 2200 grams. In a further embodiment, the structured protein products will have average shear strength of at least 2300 grams. In yet another embodiment, the structured protein products will have average shear strength of at least 2400 grams. In still another embodiment, the structured protein products will have average shear strength of at least 2500 grams. In a further embodiment, the structured protein products will have average shear strength of at least 2600 grams.

A means to quantify the size of the protein fibers formed in the structured protein products may be done by a shred characterization test. Shred characterization is a test that generally determines the percentage of large pieces formed in the structured protein product. In an indirect manner, percentage of shred characterization provides an additional means to quantify the degree of protein fiber alignment in a structured protein product. Generally speaking, as the percentage of large pieces increases, the degree of protein fibers that are aligned within a structured protein product also typically increases. Conversely, as the percentage of large pieces decreases, the degree of protein fibers that are aligned within a structured protein product also typically decreases.

A method for determining shred characterization is detailed in Example 2. The structured protein products of the invention typically have an average shred characterization of at least 10% by weight of large pieces. In a further embodiment, the structured protein products have an average shred characterization of from about 10% to about 15% by weight of large pieces. In another embodiment, the structured protein products have an average shred characterization of from about 15% to about 20% by weight of large pieces. In yet another embodiment, the structured protein products have an average shred characterization of from about 20% to about 25% by weight of large pieces. In another embodiment, the average shred characterization is at least 20% by weight, at least 21% by weight, at least 22% by weight, at least 23% by weight, at least 24% by weight, at least 25% by weight, or at least 26% by weight large pieces.

Suitable structured protein products of the invention generally have protein fibers that are substantially aligned, have average shear strength of at least 1400 grams, and have an average shred characterization of at least 10% by weight large pieces. More typically, the structured protein products will have protein fibers that are at least 55% aligned, have average shear strength of at least 1800 grams, and have an average shred characterization of at least 15% by weight large pieces. In exemplary embodiment, the structured protein products will have protein fibers that are at least 55% aligned, have average shear strength of at least 2000 grams, and have an average shred characterization of at least 17% by weight large pieces. In another exemplary embodiment, the structured protein products will have protein fibers that are at least 55% aligned, have average shear strength of at least 2200 grams, and have an average shred characterization of at least 20% by weight large pieces. In a further embodiment, the structured protein products will have protein fibers that are at least 55% aligned, have average shear strength of at least 2400 grams, and have an average shred characterization of at least 20% by weight large pieces.

(iv) Blends of Protein

It is contemplated that the animal compositions may include any combination of the animal meat, animal derived protein, or plant derived protein to meet the daily nutrient requirements of an animal. In an exemplary embodiment, the formulation will include a structured plant protein product produced by the extrusion process detailed above. Typically, the amount of structured protein product in relation to the amount of animal meat in the animal food compositions can and will vary depending upon the composition's intended use. By way of example, when a significantly vegetarian composition that has a relatively small degree of animal meat is desired, the concentration of animal meat in the animal food composition may be about 45%, 40%, 35%, 30%, 25%, 20%, 15%, 10%, 5%, 2%, or 0% by weight. Alternatively, when a animal food composition having a relatively high degree of animal meat is desired, the concentration of animal meat in the animal food composition may be about 50%, 55%, 60%, 65%, 70%, 75%, 80%, 85%, 90% or 95% by weight. Consequently, the concentration of structured protein product in the animal food composition may be about 5%, 10%, 15%, 20%, 25%, 30%, 35%, 40%, 45%, 50%, 55%, 60%, 65%, 70%, 75%, 80%, 85%, 90%, 95%, or 99% by weight. In one embodiment, the animal food product is a vegetarian composition having a concentration of animal meat of about 0% by weight and a concentration of structured plant protein product of about 30% to about 50% by weight. In a further embodiment, the animal food composition comprises from about 40% to about 60% by weight of the structured protein product and from about 40% to about 60% by weight of animal meat.

Depending upon the animal food product, the animal meat may be pre-cooked to partially dehydrate the flesh and prevent the release of those fluids during further processing applications (e.g., such as retort cooking), to remove natural liquids or oils that may have strong flavors, to coagulate the animal protein and loosen the meat from the skeleton, or to develop desirable and textural flavor properties. The pre-cooking process may be carried out in steam, water, oil, hot air, smoke, and combinations thereof. The animal meat is generally heated until the internal temperature is between 60° C. and 85° C. In one embodiment, the animal meat composition is mixed with the hydrated structured plant protein at an elevated temperature corresponding to the temperature of the meat product.

### B. Fat

The animal food compositions may have a fat content that varies widely. Typically, the animal food compositions have a fat content from about 1% to about 75% by weight of the composition. More typically, the amount may be from about 1% to about 40% by weight of the composition. For example, the amount of fat may be from about 1% to about 5%, from about 5% to about 10%, from about 10% to about 15%, from about 15% to about 20%, from about 20% to about 25%, from about 25% to about 30%, from about 30% to about 35%, from about 35% to about 40%, or greater than 40% by weight of the composition.

In one embodiment, the animal food compositions comprise dairy-based fat. Non-limiting examples of suitable dairy-based fat include butter, cheese, milk fat, and mixtures thereof. In another embodiment, the animal food compositions comprise vegetable based fat. Non-limiting examples of suitable vegetable based fat include liquid, solid, and semi-solid hydrogenated or partially hydrogenated vegetable oil such as palm oil, coconut oil, cottonseed oil, soybean oil, peanut oil, flax seed oil, grape seed oil, olive oil, and mixtures thereof. In still another embodiment, the animal food compositions comprise animal based fat. Non-limiting examples of suitable animal based fat includes tallow, lard, chicken fat, fish oil, and mixtures thereof. Typically, the animal composition will comprise a plant derived fat source when it is formulated as a vegetarian ration. Various combinations of dairy-based fat, vegetable based fat, and animal based fat can also be used.

### C. Carbohydrate and Fiber Sources

While it is contemplated that the macronutrients detailed above will contain carbohydrates and fibers, additional sources may be included to meet the daily nutrient requirements of the animal. Suitable examples of other carbohydrate sources include kamut, brown rice, oats, barley, rice, corn, milo, potatoes, corn syrup, sugar, molasses, whole wheat, quinoa, sunflower seed meal, flaxseed meal, garlic, red beets, soybean, spinach, carrot, broccoli, blueberries, rosemary, and mixtures thereof. The amount of carbohydrate may range from about 1% to about 99% by weight, more preferably from about 5% to about 50% by weight.

Suitable examples of fiber sources include cellulose, hemi-cellulose, corncobs, soy hulls, peanut hulls, rice hulls, lignin, yeast cell walls, and mixtures thereof. The animal compositions may comprise from about 1% to about 20% by weight fiber, and more typically from about 1% to about 10% by weight fiber.

### (II) Micronutrients

The animal food composition generally will comprise micronutrients in an amount necessary to meet the daily nutrient requirements of the animal. The micronutrients will comprise vitamins and minerals and optionally may include antioxidants and amino acids. In an exemplary embodiment, the micronutrient will include an omega fatty acid, such as from the linoleic fatty acid family.

The vitamins typically will include a mixture of fat-soluble and water soluble vitamins. Suitable vitamins include vitamin C, vitamin A, vitamin E, vitamin B12, vitamin K, riboflavin, niacin, vitamin D, vitamin B6, folic acid, pyridoxine, thiamine, pantothenic acid, biotin, and mixtures thereof. The form of the vitamin may include salts of the vitamin, derivatives of the vitamin, compounds having the same or similar activity of a vitamin, and metabolites of a vitamin.

Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, and selenium. Suitable forms of any of the foregoing minerals include soluble mineral salts, slightly soluble mineral salts, insoluble mineral salts, chelated minerals, mineral complexes, non-reactive minerals such as carbonyl minerals, reduced minerals, and combinations thereof.

In a further embodiment, the animal food compositions may further comprise an antioxidant. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, ice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, and combinations thereof. The concentration of an antioxidant in an animal food composition may range from about 0.0001% to about 20% by weight. In another embodiment, the concentration of an antioxidant in an animal food composition may range from about 0.001% to about 5% by weight. In yet another embodiment, the concentration of an antioxidant in an animal food composition may range from about 0.01% to about 1% by weight.

An herb may be suitable for use in certain embodiments. Herbs that may be added include basil, celery leaves, chervil, chives, cilantro, parsley, oregano, tarragon, thyme, and mixtures thereof.

The animal composition may include a polyunsaturated fatty acid (PUFA), which has at least two carbon-carbon double bonds generally in the cis-configuration. The PUFA may be a long chain fatty acid having at least 18 carbons atoms. In an exemplary embodiment, the PUFA may be an omega-3 fatty acid in which the first double bond occurs in the third carbon-carbon bond from the methyl end of the carbon chain (i.e., opposite the carboxyl acid group). Examples of omega-3 fatty acids include alpha-linolenic acid (18:3, ALA), stearidonic acid (18:4), eicosatetraenoic acid (20:4), eicosapentaenoic acid (20:5; EPA), docosatetraenoic acid (22:4), n-3 docosapentaenoic acid (22:5, n-3DPA), and docosahexaenoic acid (22:6; DHA). The PUFA may also be an omega-6 fatty acid, in which the first double bond occurs in the sixth carbon-carbon bond from the methyl end. Examples of omega-6 fatty acids include linoleic acid (18:2), gamma-linolenic acid (18:3), eicosadienoic acid (20:2), dihomo-gamma-linolenic acid (20:3), arachidonic acid (20:4), docosadienoic acid (22:2), adrenic acid (22:4), and n-6 docosapentaenoic acid (22:5). The fatty acid may also be an omega-9 fatty acid, such as oleic acid (18:1), eicosenoic acid (20:1), mead acid (20:3), erucic acid (22:1), and nervonic acid (24:1). Potential sources of the omega fatty acids include animal and vegetable fats and oils, examples include but are not limited to soybean oil, corn oil, flaxseed oil, safflower oil, and SDA oil.

### (III) Animal Food/Feed Rations

The macronutrients and micronutrients detailed above may be formulated to meet the daily nutrient requirements of several animals such as ruminants, non-ruminants, avian, aquaculture, and companion animals. In an exemplary embodiment, the formulation, irrespective of the animal, will comprise an amount of the structured plant protein product detailed in (I)(a)(iii). Typically, the amount of structured plant protein product in an animal feed ration, such as the ones described below, can and will vary depending upon the composition's intended use. In an exemplary embodiment, the animal feed ration comprises from about 1% to about 99% by weight of the structured plant protein product, or from about 1% to about 75% by weight of the structured plant protein product, or from about 1% to about 50% by weight of the structured plant protein product, or from about 1% to about 25% by weight of the structured plant protein product, or from about 1% to about 15% by weight of the structured plant protein product. Suitable types of food rations for various animals are described below.

In one embodiment, the animal ration is formulated for poultry. As noted above, feed formulations depend in part upon the age and stage of development of the animal to be fed, Leeson and Summers (Nutrition of the Chicken, 4^{th} ed., pp. 502-510, University Books 2001) describe several representative poultry diets for pullets, layers, broilers and broiler breeders. For example, most chicken diets contain energy concentrates such as corn, oats, wheat, barley, or sorghum, protein sources such as soybean meal, other oilseed meals (e.g., peanut, sesame, safflower, sunflower, etc.), cottonseed meal, animal protein sources (meat and bone meal, dried whey, fish meal, etc.), grain legumes (e.g., dry beans, field peas, etc.), and alfalfa; and vitamin and mineral supplements, if necessary (for instance, meat and bone meal is high in calcium and phosphorous, and thus these minerals do not need to be supplemented in a feed ration containing meat and bone meal). The relative amounts of the different ingredients in poultry feed depend in part upon the production stage of the bird. Starter rations are higher in protein, while grower and finisher feeds can be lower in protein since older birds require less protein.

In another embodiment, the animal feed ration is formulated for a ruminant animal. The nutrient and energy content of many common ruminant feed ingredients have been measured and are available to the public. The National Research Council has published books that contain tables of common ruminant feed ingredients and their respective measured nutrient and energy content. Additionally, estimates of nutrient and maintenance energy requirements are provided for growing and finishing cattle according to the weight of the cattle. National Academy of Sciences, Nutrient Requirements of Beef Cattle, Appendix Tables 1-19, 192-214, (National Academy Press, 2000); Nutrient Requirements of Dairy Cattle (2001), each incorporated herein in its entirety. Example 6 illustrates specific feed rations for cattle and dairy cattle.

In another embodiment, the animal ration is formulated for swine. The feed formulation will vary for piglets, grower pigs, gestating sows, and lactating sows. Swine feed formulations typically comprise grains (e.g., corn, barley, grain sorghum, oats, soybeans, wheat, etc.), crude proteins (e.g., fish meal, gluten meal, meat meal, soybean meal, tankage, which is the residue that remains after rendering fat in a slaughterhouse, etc.), crude fat (e.g., fish oils, vegetable oils, animal fats, yellow grease, etc.), supplemental amino acids (e.g., lysine, methionine or methionine analogs, etc), vitamins, minerals, mycotoxin inhibitors, antifungal agents, and pharma/nutriceuticals. In one embodiment, the animal ration is formulated for a piglet nursery diet. Typically, the piglet nursery diet formulation contains from about 15% to about 30% by weight crude protein; from about 2.5% to about 15% by weight crude fat; and from about 3.5% to about 10% by weight crude fiber. Examples of animal feed formulations can be found in the National Academies Press 1998 National Research Council Nutrient Requirement of Swine (incorporated by reference).

In an exemplary embodiment, the animal composition will be formulated to meet the requirements of a companion animal. Suitable companion animals include dogs, cats, rabbits, rodents, snakes, and birds. In an exemplary embodiment, the companion animal is a dog or cat. Dog and cat food formulations are generally formulated to meet the nutritional requirements established by the Association of American Feed Control Officials (AAFCO). By way of example, a balanced diet for a dog according to AAFCO standards is shown in the table below:

AAFCO Dog Food Nutrient Profiles^{a}

| | Units | Growth and | Adult | |
|---|---|---|---|---|
| | DM | Reproduction | Maintenance | |
| Nutrient | Basis | Minimum | Minimum | Maximum |
| Protein | % | 22.0 | 18.0 | — |
| Arginine | % | 0.62 | 0.51 | — |
| Histidine | % | 0.22 | 0.18 | — |
| Isoleucine | % | 0.45 | 0.37 | — |
| Leucine | % | 0.72 | 0.59 | — |
| Lysine | % | 0.77 | 0.63 | — |
| Methionine- | % | 0.53 | 0.43 | — |
| cystine | | | | |
| Phenylalanine- | % | 0.89 | 0.73 | — |
| tyrosine | | | | |
| Threonine | % | 0.58 | 0.48 | — |
| Tryptophan | % | 0.20 | 0.16 | — |
| Valine | % | 0.48 | 0.39 | — |
| Fat^{b} | % | 8.0 | 5.0 | — |
| Linoleic acid | % | 1.0 | 1.0 | — |

Minerals

| | | | | |
|---|---|---|---|---|
| Calcium | % | 1.0 | 0.6 | 2.5 |
| Phosphorous | % | 0.8 | 0.5 | 1.6 |
| Ca:P ratio | | 1:1 | 1:1 | 2:1 |
| Potassium | % | 0.6 | 0.6 | — |
| Sodium | % | 0.3 | 0.06 | — |
| Chloride (Cl) | % | 0.45 | 0.09 | — |
| Magnesium | % | 0.04 | 0.04 | 0.3 |
| Iron^{c} | mg/kg | 80.0 | 80.0 | 3,000.0 |
| Copper^{d} | mg/kg | 7.3 | 7.3 | 250.0 |
| Manganese | mg/kg | 5.0 | 5.0 | — |
| Zinc | mg/kg | 120.0 | 120.0 | 1,000.0 |
| Iodine | mg/kg | 1.5 | 1.5 | 50.0 |
| Selenium | mg/kg | 0.11 | 0.11 | 2.0 |

Vitamins

| | | | | |
|---|---|---|---|---|
| Vitamin A | IU/kg | 5,000.0 | 5,000.0 | 250,000.0 |
| Vitamin D | IU/kg | 500.0 | 500.0 | 5,000.0 |
| Vitamin E | IU/kg | 50.0 | 50.0 | 1,000.0 |
| Vitamin B1 | mg/kg | 1.0 | 1.0 | — |
| (thiamin)^{e} | | | | |
| Vitamin B2 | mg/kg | 2.2 | 2.2 | — |
| (riboflavin) | | | | |
| Vitamin B5 | mg/kg | 10.0 | 10.0 | — |
| (pantothenic | | | | |
| acid) | | | | |
| Vitamin B3 | mg/kg | 11.4 | 11.4 | — |
| (niacin) | | | | |
| Vitamin B6 | mg/kg | 1.0 | 1.0 | — |
| (pyridoxine) | | | | |
| Folic Acid | mg/kg | 0.18 | 0.18 | — |
| Vitamin B12 | μg/kg | 22.0 | 22.0 | — |
| (cyanocobalamin) | | | | |
| Choline | g/kg | 1.2 | 1.2 | — |

^{a}Presumes an energy density of 3.5 kcal ME/g DM (metabolizable energy/gram dry matter), as determined in accordance with Regulation PF9, which is based on the ‘modified Atwater’ values of 3.5, 8.5, and 3.5 kcal/g for protein, fat, and carbohydrate (nitrogen-free extract, NFE), respectively. Rations greater than 4.0 kcal/g should be corrected for energy density; rations less than 3.5 kcal/g should not be corrected for energy. Rations of low-energy density should not be considered adequate for growth or reproductive needs based on comparison to the Profiles alone.
^{b}Although a true requirement for fat per se has not been established, the minimum level was based on recognition of fat as a source of essential fatty acids, as a carrier of fat-soluble vitamins, to enhance palatability, and to supply an adequate caloric density.
^{c}Because of very poor bioavailability, iron from carbonate or oxide sources that are added to the diet should not be considered as components in meeting the minimum nutrient level.
^{d}Because of very poor bioavailability, copper from oxide sources that are added to the diet should not be considered as components in meeting the minimum nutrient level.
^{e}Because processing may destroy up to 90 percent of the thiamin in the diet, allowance in formulation should be made to ensure the minimum nutrient level is met after processing.

By way of yet a further example, a balanced diet for a cat according to the AAFCO standards is shown in the table below:

AAFCO Cat Food Nutrient Profiles^{a}

| | Units | Growth and | Adult | |
|---|---|---|---|---|
| | DM | Reproduction | Maintenance | |
| Nutrient | Basis | Minimum | Minimum | Maximum |
| Protein | % | 30.0 | 26.0 | — |
| Arginine | % | 1.25 | 1.04 | — |
| Histidine | % | 0.31 | 0.31 | — |
| Isoleucine | % | 0.52 | 0.52 | — |
| Leucine | % | 1.25 | 1.25 | — |
| Lysine | % | 1.20 | 0.83 | — |
| Methionine- | % | 1.10 | 1.10 | — |
| cystine | | | | |
| Methionine | % | 0.62 | 0.62 | 1.50 |
| Phenylalanine- | % | 0.88 | 0.88 | — |
| tyrosine | | | | |
| Phenylalanine | % | 0.42 | 0.42 | — |
| Threonine | % | 0.73 | 0.73 | — |
| Tryptophan | % | 0.25 | 0.16 | — |
| Valine | % | 0.62 | 0.62 | — |
| Taurine | % | 0.10 | 0.10 | — |
| (extruded) | | | | |
| Taurine | % | 0.20 | 0.20 | — |
| (canned) | | | | |
| Fat^{b} | % | 9.0 | 9.0 | — |
| Linoleic acid | % | 0.5 | 0.5 | — |
| Arachidonic | % | 0.02 | 0.02 | — |
| acid | | | | |

Minerals

| | | | | |
|---|---|---|---|---|
| Calcium | % | 1.0 | 0.6 | — |
| Phosphorous | % | 0.8 | 0.5 | — |
| Potassium | % | 0.6 | 0.6 | — |
| Sodium | % | 0.2 | 0.2 | — |
| Chloride | % | 0.3 | 0.3 | — |
| Magnesium^{c} | % | 0.08 | 0.04 | — |
| Iron^{d} | mg/kg | 80.0 | 80.0 | — |
| Copper (extruded)^{e} | mg/kg | 15.0 | 5.0 | — |
| Copper | mg/kg | 5.0 | 5.0 | — |
| (canned)^{e} | | | | |
| Manganese | mg/kg | 7.5 | 7.5 | — |
| Zinc | mg/kg | 75.0 | 75.0 | 2,000.0 |
| Iodine | mg/kg | 0.35 | 0.35 | — |
| Selenium | mg/kg | 0.1 | 0.1 | — |

Vitamins

| | | | | |
|---|---|---|---|---|
| Vitamin A | IU/kg | 9,000.0 | 5,000.0 | 750,000.0 |
| Vitamin D | IU/kg | 750.0 | 500.0 | 10,000.0 |
| Vitamin E^{f} | IU/kg | 30.0 | 30.0 | — |
| Vitamin K^{g} | mg/kg | 0.1 | 0.1 | — |
| Vitamin B1 (thiamin)^{h} | mg/kg | 5.0 | 5.0 | — |
| Vitamin B2 (riboflavin) | mg/kg | 4.0 | 4.0 | — |
| Vitamin B5 (pantothenic acid) | mg/kg | 5.0 | 5.0 | — |
| Vitamin B3 (niacin) | mg/kg | 60.0 | 60.0 | — |
| Vitamin B6 (pyridoxine) | mg/kg | 4.0 | 4.0 | — |
| Folic Acid | mg/kg | 0.8 | 0.8 | — |
| Biotinⁱ | mg/kg | 0.07 | 0.07 | — |
| Vitamin B12 (cyanocobalamin) | μg/kg | 20.0 | 20.0 | — |
| Choline^{j} | g/kg | 2.4 | 2.4 | — |

^{a}Presumes an energy density of 3.5 kcal ME/g DM (metabolizable energy/gram dry matter), as determined in accordance with Regulation PF9, which is based on the ‘modified Atwater’ values of 3.5, 8.5, and 3.5 kcal/g for protein, fat, and carbohydrate (nitrogen-free extract, NFE), respectively. Rations greater than 4.0 kcal/g should be corrected for energy density; rations less than 3.5 kcal/g should not be corrected for energy. Rations of low-energy density should not be considered adequate for growth or reproductive needs based on comparison to the Profiles alone.
^{b}Although a true requirement for fat per se has not been established, the minimum level was based on recognition of fat as a source of essential fatty acids, as a carrier of fat-soluble vitamins, to enhance palatability, and to supply an adequate caloric density.
^{c}If the mean urine pH of cats fed ad libitum is not below 6.4, the risk of struvite urolithiasis increases as the magnesium content of the diet increases.
^{d}Because of very poor bioavailability, iron from carbonate or oxide sources that are added to the diet should not be considered as components in meeting the minimum nutrient level.
^{e}Because of very poor bioavailability, copper from oxide sources that are added to the diet should not be considered as components in meeting the minimum nutrient level.
^{f}Add 10 IU vitamin E above minimum level per gram of fish oil per kilogram of diet.
^{g}Vitamin K does not need to be added unless diet contains greater than 25 percent fish on a dry matter basis.
^{h}Because processing may destroy up to 90 percent of the thiamin in the diet, allowance in formulation should be made to ensure the minimum nutrient level is met after processing.
ⁱBiotin does not need to be added unless diet contains antimicrobial or antivitamin compounds.
^{j}Methionine may be used to substitute for choline as a methyl donor at a rate of 3.75 parts for 1 part choline by weight when methionine exceeds 0.62 percent.

(IV) Preparation of a Food/Feed Ration having Structured Plant Protein

The food/feed formulations as detailed above, generally include a structured plant protein product to meet at least a portion of the recited protein requirement. Typically, the process of making a food composition, particularly for a companion animal, involves hydrating the structured plant protein product and reducing its size, optionally coloring and flavoring it, and then blending it with the rest of the ingredients that form the food composition. It is generally envisioned that for non-companion animals, such as livestock, that the structure plant protein product may have its particle sized reduced to an appropriate size and be added to the feed formulation substantially dry (i.e., with a water content of less than approximately 10%).

In an exemplary embodiment, the animal food composition is prepared for a companion animal. For this application, the amount of water added to the structured plant protein product can and will vary depending on the type of companion animal food composition desired. The water may be added to the structured plant protein product. Alternatively, water, structured plant protein product, and additional ingredients forming the food composition may be mixed at the same time. Irrespective of when the ingredients are combined, dry, semi-moist, and moist (also referred to as canned) are the three primary animal food compositions for companion animal food, which are characterized by their moisture content. Typically, dry animal food compositions have a moisture content of less than 25% by weight. In one embodiment, the dry animal food composition has a moisture content of about 10% to about 20% by weight. In an exemplary embodiment, the dry animal food composition has a moisture content of less than about 12% by weight. Semi-moist animal food compositions typically have a moisture content of less than 40% by weight. In one embodiment, the semi-moist animal food composition has a moisture content of about 20% to about 35% by weight. In an exemplary embodiment, the semi-moist animal food composition has a moisture content of about 25% to about 30% by weight. Typically, moist or canned animal food compositions have a moisture content of less than 90% by weight. In one embodiment, the moist or canned animal food composition has a moisture content of about 40% to about 85% by weight. In an exemplary embodiment, the moist or canned animal food composition has a moisture content of about 70% to about 80% by weight.

It is also envisioned that the structured protein product may be combined with a suitable coloring agent such that the color of the composition resembles the color of animal meat. The animal food compositions of the invention may be colored to resemble dark animal meat or light animal meat. By way of example, the animal food composition may be colored with a natural colorant, a combination of natural colorants, an artificial colorant, a combination of artificial colorants, or a combination of natural and artificial colorants. Suitable examples of natural colorants approved for use in food include annatto (reddish-orange), anthocyanins (red to blue, depends upon pH), beet juice, beta-carotene (orange), beta-APO 8 carotenal (orange), black currant, burnt sugar; canthaxanthin (pink-red), caramel, carmine/carminic acid (bright red), cochineal extract (red), curcumin (yellow-orange); lutein (red-orange); mixed carotenoids (orange), monascus (red-purple, from fermented red rice), paprika, red cabbage juice, riboflavin (yellow), saffron, titanium dioxide (white), turmeric (yellow-orange), and mixtures thereof. Suitable examples of artificial colorants approved for use in food include FD&C (Food Drug & cosmetics) Red Nos. 3 (carmosine), 4 (fast red E), 7 (ponceau 4R), 9 (amaranth), 14 (erythrosine), 17 (allura red), 40 (allura red AC) and FD&C Yellow Nos. 5 (tartrazine), 6 (sunset yellow), 13 (quinoline yellow), and mixtures thereof. Food colorants may be dyes, which are powders, granules, or liquids that are soluble in water. Alternatively, natural and artificial food colorants may be lake colors, which are combinations of dyes and insoluble materials. Lake colors are not oil soluble, but are oil dispersible; they tint by dispersion.

The type of colorant or colorants and the concentration of the colorant or colorants will be adjusted to match the color of the animal meat to be simulated. The final concentration of a natural food colorant may range from about 0.01% percent to about 4% by weight.

The color system may further comprise an acidity regulator to maintain the pH in the optimal range for the colorant. The acidity regulator may be an acidulent. Examples of acidulents that may be added to food include citric acid, acetic acid (vinegar), tartaric acid, malic acid, fumaric acid, lactic acid, phosphoric acid, sorbic acid, benzoic acid, and mixtures thereof. The final concentration of the acidulent in an animal food composition may range from about 0.001% to about 5% by weight. The final concentration of the acidulent may range from about 0.01% to about 2% by weight. The final concentration of the acidulent may range from about 0.1% to about 1% by weight. The acidity regulator may also be a pH-raising agent, such as disodium diphosphate.

The coloring composition of the present invention may be prepared by combining the components using processes and procedures known to those of ordinary skill in the art. The components are typically available in either a liquid form or a powder form, and often in both forms. The components can be mixed directly to form the coloring composition, but preferably the ingredients of the coloring composition are combined in an aqueous solution at a total concentration of about 10% to about 25% by weight, where the aqueous coloring solution can be conveniently added to a quantity of water for mixing with and coloring a structured protein product.

It is also envisioned that the structured protein product may be combined with a suitable pH-lowering agent to increase the chew or toughness of the product. The pH-lowering agent may be suitably contacted with the compositions, or products forming the composition, at various stages of the composition's manufacture. In one embodiment, the pH-lowering agent is contacted with the plant protein material and the mixture is then extruded according to the process detailed herein. Alternatively, the pH-lowering agent may be contacted with the structured plant protein product after it has been extruded.

Irrespective of the stage of manufacture at which the pH-lowering agent is introduced, suitable agents include those that will lower the pH of the composition to below approximately 7.0. In one embodiment, the pH is below approximately 7.0. In another embodiment, the pH is between about 6.0 to about 7.0. In still another embodiment, the pH is below approximately 6.0. In another embodiment, the pH is between about 5.0 and about 6.0. In one alternative of this embodiment, the pH is between about 5.2 to about 5.9. In still another alternative of this embodiment, the pH is between about 5.4 to about 5.8. In an additional alternative of this embodiment, the pH is about 5.6. In another embodiment, the pH is below approximately 5.0. In a further embodiment, the pH is between about 4.0 to about 5.0. In still another embodiment, the pH is below approximately 4.0.

Several pH-lowering agents are suitable for use in the invention. The pH-lowering agent may be organic. Alternatively, the pH-lowering agent may be inorganic. In exemplary embodiments, the pH-lowering agent is a food grade edible acid. Non-limiting acids suitable for use in the invention include acetic, lactic, hydrochloric, phosphoric, citric, tartaric, malic, and combinations thereof. In an exemplary embodiment, the pH-lowering agent is lactic acid.

As will be appreciated by a skilled artisan, the amount of pH-lowering agent utilized in the invention can and will vary depending upon several parameters, including, the agent selected, the desired pH, and the stage of manufacture at which the agent is added. By way of non-limiting example, the amount of pH-lowering agent combined with the plant protein material may range from about 0.1% to about 15% on a dry matter basis. In another embodiment, the amount of pH-lowering agent may range from about 0.5% to about 10% on a dry matter basis. In an additional embodiment, the amount of pH-lowering agent may range from about 1% to about 5% on a dry matter basis. In other embodiments, the amount of pH-lowering agent may range from about 2% to about 3% on a dry matter basis. In another embodiment, the amount of pH-lowering agent is about 2.5% on a dry matter basis.

The animal food compositions may optionally include a variety of flavorings. Suitable flavoring agents include animal meat flavor, animal meat oil, spice extracts, spice oils, natural smoke solutions, natural smoke extracts, yeast extracts, and combinations thereof. Other flavoring agents include onion flavor, garlic flavor, or herb flavor. Examples of suitable flavor enhancers include sodium chloride salt, glutamic acid salts, glycine salts, guanylic acid salts, inosinic acid salts, 5-ribonucleotide salts, and combinations thereof.

Generally speaking, companion animal composition comprising structured plant protein products may be combined with the macronutrients and micronutrients to meet the nutrient requirements of the animal, as detailed herein or otherwise known in the art. The animal composition, depending upon its moisture content, may be canned, formed into a dry kibble, or formed into a gravy according to methods generally known in the art.

### (V) Companion Animal Treats

The structured plant protein products may also be included as an ingredient in several treats. Suitable examples of treats include biscuits, semi-moist treats, jerky, animal hide, food supplements, and dental treats. Typically, biscuits include wheat flour and animal or plant protein. Animal or plant proteins may be included, for example, in the form of meal, flour, caseinate, and gluten. Semi-moist treats may include animal meat, such as cow or chicken livers, chicken breast, tuna, salmon, or a combination of grains or starches surrounding pieces of animal meat. Jerky treats typically include, for example, pieces of beef, chicken, lamb, salmon, or tuna. Animal hide treats typically include cow, pig, or buffalo hide, but may also be wrapped around animal meat such as, for example, pieces of chicken breast. Dental treats, typically used to reduce tartar and plaque buildup on a pet's teeth, include fibers, grains, in addition to plant or animal protein.

### DEFINITIONS

The term “animal meat” as used herein refers to the flesh, whole meat muscle, or parts thereof derived from an animal.

The term “comminuted meat” as used herein refers to a meat paste that is recovered from an animal carcass. The meat, on or off the bone is forced through a deboning device such that meat is separated from the bone and reduced in size.

The term “extrudate” as used herein refers to the product of extrusion. In this context, the plant protein products comprising protein fibers that are substantially aligned may be extrudates in some embodiments.

The term “fiber” or as used herein refers to a plant protein product having a size of approximately 4 centimeters in length and 0.2 centimeters in width after the shred characterization test detailed in Example 2 is performed. In this context, the term “fiber” does not include the nutrient class of fibers, such as soybean cotyledon fibers, and also does not refer to the structural formation of substantially aligned protein fibers comprising the plant protein products.

The term “gluten” as used herein refers to a protein fraction in cereal grain flour, such as wheat, that possesses a high content of protein as well as unique structural and adhesive properties.

The term “gluten free starch” as used herein refers to various starch products such as modified tapioca starch. Gluten free or substantially gluten free starches are made from wheat, corn, and tapioca based starches. They are gluten free because they do not contain the gluten from wheat, oats, rye or barley.

The term “hydration test” as used herein measures the amount of time in minutes necessary to hydrate a known amount of the protein composition.

The term “large piece” as used herein is the manner in which a colored or uncolored structured plant protein product's shred percentage is characterized. The determination of shred characterization is detailed in Example 2.

The term “mechanically deboned meat (MDM)” as used herein refers to a meat paste that is recovered from beef, pork and chicken bones using commercially available equipment. MDM is a comminuted product that is devoid of the natural fibrous texture found in intact muscles.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety.

The term “organic” as used herein refers to food compositions that have been manufactured and handled according to specific National Organic Program requirements under 7 C.F.R. Part 205.

The term “natural” as used herein refers to a food composition that meets the guidelines according to AAFCO where “a feed or ingredient derived solely form plant, animal, or mined sources either in its unprocessed state or having been subject to physical processing, heat processing, rendering, purification, extraction, hydrolysis, enzymolysis or fermentation, but not having been produced by or subject to a chemically synthetic process and not containing any additives or processing aids that are chemically synthetic except in amount as might occur unavoidably in good manufacturing practices.

The term “protein content,” as for example, soy protein content as used herein, refers to the relative protein content of a material as ascertained by A.O.C.S. (American Oil Chemists Society) Official Methods Bc 4-91 (1997), Aa 5-91 (1997), or Ba 4d-90 (1997), each incorporated herein by reference in their entirety, which determine the total nitrogen content of a material sample as ammonia, and the protein content as 6.25 times the total nitrogen content of the sample.

The term “protein fiber” as used herein refers to the individual continuous filaments or discrete elongated pieces of varying lengths that together define the structure of the plant protein products of the invention. Additionally, because both the colored and uncolored structured plant protein products of the invention have protein fibers that are substantially aligned, the arrangement of the protein fibers impart the texture of whole meat muscle to the colored and uncolored structured plant protein products.

The term “shear strength” as used herein measures the ability of a textured protein to form a fibrous network with a strength high enough to impart meat-like texture and appearance to a formed product. Shear strength is measured in grams.

The term “simulated” as used herein refers to an animal food composition that contains no animal meat.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and carbohydrates of the cotyledon.

The term “soy protein concentrate” as used herein is a soy material having a protein content of from about 65% to less than about 90% soy protein on a moisture-free basis. Soy protein concentrate may also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon. Further, the soy protein and soy cotyledon fiber may be separated from the soluble carbohydrates of the cotyledon.

The term “soy flour” as used herein, refers to full fat soy flour, enzyme-active soy flour, defatted soy flour and mixtures thereof. Defatted soy flour refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S., Standard) screen. Full fat soy flour refers to ground whole soybeans containing all of the original oil, usually 18 to 20%. The flour may be enzyme-active or it may be heat-processed or toasted to minimize enzyme activity. Enzyme-active soy flour refers to a full fat soy flour that has been minimally heat-treated in order not to neutralize its natural enzymes.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “strand” as used herein refers to a plant protein product having a size of approximately 2.5 to about 4 centimeters in length and greater than approximately 0.2 centimeter in width after the shred characterization test detailed in Example 2 is performed.

The term “starch” as used herein refers to starches derived from any native source. Typically sources for starch are cereals, tubers, roots, legumes, and fruits.

The term “weight on a moisture free basis” as used herein refers to the weight of a material after it has been dried to completely remove all moisture, e.g. the moisture content of the material is 0%. Specifically, the weight on a moisture free basis of a material can be obtained by weighing the material after the material has been placed in a 45° C. oven until the material reaches a constant weight.

The term “wheat flour” as used herein refers to flour obtained from the milling of wheat. Generally speaking, the particle size of wheat flour is from about 14 to about 120 μm.

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### EXAMPLES

The following examples illustrate the animal food compositions of the invention.

### Example 1

### Determination of Shear Strength

Shear strength of a sample is measured in grams and may be determined by the following procedure. Weigh a sample of the structured protein product and place it in a heat sealable pouch and hydrate the sample with approximately three times the sample weight of room temperature tap water. Evacuate the pouch to a pressure of about 0.01 Bar and seal the pouch. Permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45, incisor blade manufactured by Texture Technologies (Scarsdale, N.Y.). A suitable texture analyzer to perform this test is a model TA, TXT2 manufactured by Stable Micro Systems Ltd. (England) equipped with a 25, 50, or 100 kilogram load. Within the context of this test, shear strength is the maximum force in grams needed to shear through the sample.

### Example 2

### Determination of Shred Characterization

A procedure for determining shred characterization may be performed as follows. Weigh about 150 grams of a structured plant protein product using whole pieces only. Place the sample into a heat-sealable plastic bag and add about 450 grams of water at 25° C. Vacuum seal the bag at about 150 mm Hg and allow the contents to hydrate for about 60 minutes. Place the hydrated sample in the bowl of a Kitchen Aid mixer model KM14G0 equipped with a single blade paddle and mix the contents at 130 rpm for two minutes. Scrape the paddle and the sides of the bowl, returning the scrapings to the bottom of the bowl. Repeat the mixing and scraping two times. Remove ˜200 g of the mixture from the bowl. Separate the ˜200 g of mixture into one of two groups. Group 1 is the portion of the sample having fibers at least 4 centimeters in length and at least 0.2 centimeters wide. Group 2 is the portion of the sample having strands between 2.5 cm and 4.0 cm long, and which are ≧0.2 cm wide. Weigh each group, and record the weight. Add the weight of each group together, and divide by the starting weight (e.g. ˜200 g). This determines the percentage of large pieces in the sample. If the resulting value is below 15%, or above 20%, the test is complete. If the value is between 15% and 20%, then weigh out another 200 g from the bowl, separate the mixture into groups one and two, and perform the calculations again.

### Example 3

### Production of Plant Protein Products

The following extrusion process may be used to prepare the structured plant protein products of the invention, such as the soy structured plant protein products utilized in Examples 1 and 2. Added to a dry blend mixing tank are the following: 1000 kilograms (kg) Supro® 620 (soy isolate), 440 kg wheat gluten, 171 kg wheat starch, 34 kg soy cotyledon fiber, 9 kg dicalcium phosphate, and 1 kg L-cysteine. The contents are mixed to form a dry blended soy protein mixture. The dry blend is then transferred to a hopper from which the dry blend is introduced into a preconditioner along with 480 kg of water to form a conditioned soy protein pre-mixture. The conditioned soy protein pre-mixture is then fed to a twin-screw extrusion apparatus (Wenger Model TX-168 extruder by Wenger Manufacturing, Inc. (Sabetha, Kans.)) at a rate of not more than 25 kg/minute. The extrusion apparatus comprises five temperature control zones, with the protein mixture being controlled to a temperature of from about 25° C. in the first zone, about 50° C. in the second zone, about 95° C. in the third zone, about 130° C. in the fourth zone, and about 150° C. in the fifth zone. The extrusion mass is subjected to a pressure of at least about 400 psig in the first zone up to about 1500 psig in the fifth zone. Water, 60 kg per hour, is injected into the extruder barrel, via one or more injection jets in communication with a heating zone. The molten extruder mass exits the extruder barrel through a die assembly consisting of a die and a backplate. As the mass flows through the die assembly the protein fibers contained within are substantially aligned with one another forming a fibrous extrudate. As the fibrous extrudate exits the die assembly, it is cut with flexible knives and the cut mass is then dried to a moisture content of about 10% by weight.

### Example 4

### Companion Animal Food Composition

A companion animal food composition within the scope of the present invention may be formed by employing a mixture of the components or ingredients listed in Table 1 shown below, on a percent by weight basis.

Soy, wheat middling and corn may be combined to yield a premix, which is blended to form a substantially homogeneous mixture. To the premix may then be added vitamins, trace minerals and flavorings. The resultant mixture may then blended a second time.

Subsequent to blending, the mixture may be extruded in accordance with the procedure in detailed herein. The extruded protein product may then be dried in a dryer.

TABLE 1

| | |
|---|---|
| Soy | 47.00 |
| Wheat | 20.00 |
| Ground Corn | 10.95 |
| Vegetable Oil | 10.00 |
| Phosphate dicalcium | 3.15 |
| Yeast | 2.50 |
| Vitamins | 2.90 |
| Pectin | 2.00 |
| Salt | 0.75 |
| Calcium Carbonate | 0.60 |
| Ascorbic Acid | 0.10 |
| Flavoring agent | 0.05 |

### Example 5

### Companion Animal Food Composition

A companion animal food composition within the scope of the present invention may also formed by employing the extruded protein product of example 4 and combining it with chicken meat in a 1.1 ratio.

### Example 6

### Ruminant Feed Rations

For each of the ruminant rations detailed below, from about 1% to about 10% by weight of the structured plant protein product may be added as a protein source. The 1% to about 10% by weight of the structured plant protein can be substituted for the ingredients listed below. As an example the structured plant protein could replace the ingredients on a nutrient equivalent basis, including but not limited to an amino acid alternative.

An example of a suitable dairy cow feed ration for a cow in the first 35 days of the dry cycle is as follows:

| | Percent by Weight (DM basis) |
|---|---|
| Ingredient | of Total Feed Composition |
| Steamrolled Corn | 8.0 |
| Wheat straw | 8.5 |
| Alfalfa hay | 38.0 |
| Corn silage | 41.0 |
| Trace Mineral Salts | 4.5 |

A suitable example of a dairy cow feed ration for a cow at day 0 to 14 of the lactation cycle is as follows:

| | Percent by Weight (DM basis) |
|---|---|
| Ingredient | of Total Feed Composition |
| Steamrolled Corn | 8.0 |
| Soybean meal (44%) | 7.5 |
| Alfalfa hay | 17.0 |
| Corn silage | 47.0 |
| Nutrichlor 18-8 | 16.0 |
| Trace Mineral Salts | 4.5 |

An example of a suitable dairy cow feed ration for a cow at day 14 to 80 of the lactation cycle is as follows:

| | Percent by Weight (DM basis) |
|---|---|
| Ingredient | of Total Feed Composition |
| Steamrolled Corn | 15.0 |
| Soybean meal (44%) | 13.0 |
| Alfalfa hay | 22.0 |
| Corn silage | 21.0 |
| Distillers grains | 8.0 |
| Whole Cottonseed | 10.0 |
| Soybean hulls | 6.5 |
| Trace Mineral Salts | 4.5 |

A feed ration may also be formulated to meet the nutritional requirements of non-dairy cattle, and in particular, feedlot cattle. The percentage of each type of component in the cattle diet (i.e. grain to roughage ratio) depends upon the dietary requirements of the particular animal. By way of example, a feed composition typically fed to feedlot cattle on an intermediate or growing diet may include:

| | Percent by Weight of |
|---|---|
| Ingredient | Total Feed Composition |
| Dehydrated Alfalfa Meal | 25.0 |
| Cottonseed Hulls | 5.0 |
| Steamrolled Corn | 60.0 |
| Soybean meal (44%) | 3.0 |
| Calcium Carbonate | 1.0 |
| Sodium Tripolyphosphate | 0.5 |
| Cane Molasses | 5.0 |
| Trace Mineral Salts | 0.5 |

The intermediate diet contains a moderate energy to roughage ratio and is fed to cattle during their growth stage. After the intermediate diet, a higher energy finishing diet is substituted until the cattle are ready for slaughter. A typical finishing diet may include:

| | Percent by Weight of |
|---|---|
| Ingredient | Total Feed Composition |
| Dehydrated Alfalfa Meal | 5.0 |
| Cottonseed Hulls | 10.0 |
| Steamrolled Corn | 74.8 |
| Soybean meal (44%) | 3.0 |
| Calcium Carbonate | 0.7 |
| Sodium Tripolyphosphate | 0.3 |
| Cane Molasses | 5.0 |

### Example 7

### Swine Feed Rations

Swine feed formulations typically comprise grains (e.g., corn, barley, grain sorghum, oats, soybeans, wheat, etc.), crude proteins (e.g., fish meal, gluten meal, meat meal, soybean meal, tankage, which is the residue that remains after rendering fat in a slaughterhouse, etc.), crude fat (e.g., fish oils, vegetable oils, animal fats, yellow grease, etc.), supplemental amino acids (e.g., lysine, methionine or methionine analogs, etc), vitamins, minerals, mycotoxin inhibitors, antifungal agents, and pharma/nutriceuticals. Swine feed formulations may typically comprise from about 1% to about 10% by weight of the structured plant protein product as a protein source. The 1% to about 10% by weight of the structured plant protein can be substituted for the ingredients listed below. As an example the structured plant protein could replace the ingredients on a nutrient equivalent basis, including but not limited to an amino acid alternative.

An example of a suitable swine starter diet is as follows:

| | Percent by Weight of |
|---|---|
| Ingredient | Total Feed Composition |
| Bone meal | 2.5 |
| Dried whey | 2.5 |
| Fish meal | 2.5 |
| Dried skim milk | 5.0 |
| Soybean meal (44%) | 15.0 |
| Sugar | 10.0 |
| Ground corn | 27.0 |
| Rolled oats | 35.0 |
| Trace Mineral Salts | 0.5 |

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the following claims.

What is claimed is:

1. An animal food composition, the composition comprising:
(a) a structured plant protein product comprising protein fibers that are substantially aligned, the structured plant protein product comprising an extrudate of plant protein material;
(b) a fat substance in an amount sufficient to meet the daily nutrient requirement of the animal, and
(c) at least one nutrient selected from the group consisting of vitamins and minerals in an amount sufficient to meet the daily nutrient requirement of the animal.

2. The animal food composition of claim 1, further comprising animal meat, wherein the animal meat is selected from the group consisting of pork, beef, lamb, poultry, wild game, fish, and combinations thereof.

3. The animal food composition of claim 2, wherein the composition comprises from about 40% to about 60% by weight of the structured protein product, and from about 40% to about 60% by weight animal meat.

4. The animal food composition of claim 1, wherein the structured protein product comprises protein fibers substantially aligned in the manner depicted in the micrographic image of FIG. 1.

5. The animal food composition of claim 1, wherein the structured plant protein product has an average shear strength of at least 1400 grams and an average shred characterization of at least 10%.

6. The animal food composition of claim 1, wherein the structured plant protein product is selected from the group consisting of soy protein, soy protein isolate, soy protein concentrate, starch, gluten, fiber, and combinations thereof.

7. The animal food composition of claim 1, wherein the structured plant protein product comprises:
(a) from about 35% to about 65% soy protein on a dry matter basis;
(b) from about 20% to about 30% wheat gluten on a dry matter basis;
(c) from about 10% to about 15% wheat starch on a dry matter basis; and,
(d) from about 1% to about 5% starch on a dry matter basis.

8. The animal food composition of claim 1, wherein the fat substance is selected from the group consisting of a dairy based fat, a vegetable based fat, an animal based fat, and mixtures thereof.

9. The companion animal food composition of claim 8, wherein the dairy based fat is selected from the group consisting of butter, cheese, milk fat, and mixtures thereof.

10. The animal food composition of claim 8, wherein the vegetable based fat is hydrogenated or partially hydrogenated vegetable oil, wherein the hydrogenated or partially hydrogenated vegetable oil is selected from the group consisting of palm oil, coconut oil, cottonseed oil, soybean oil, peanut oil, flax seed oil, grape seed oil, olive oil, and mixtures thereof.

11. The animal food composition of claim 8, wherein the animal based fat is selected from the group consisting of tallow, lard, chicken fat, fish oil, and mixtures thereof.

12. The animal food composition of claim 1, further comprising nutrients selected from the group consisting of a vitamin mixture, a fatty acid, pectin, taurine, and mixtures thereof, wherein the vitamin mixture comprises vitamin C and vitamin E, wherein the fatty acid is selected form the group consisting of polyunsaturated fatty acid, omega-3 fatty acid, omega-6 fatty acid, omega-9 fatty acid, and mixtures thereof.

13. The animal food composition of claim 12, wherein the nutrients comprise an amount from about 1.0% to about 10.0% by weight of the animal food composition.

14. The companion animal food composition of claim 12, further comprising pectin in an amount from about 0.01% to about 5.0% by weight.

15. The companion animal food composition of claim 12, further comprising taurine in an amount from about 0.05% to about 0.1% by weight.

16. A companion animal food composition, the composition comprising:
(a) a structured plant protein product comprising protein fibers that are substantially aligned, the structured plant protein product comprising an extrudate of plant protein material;
(b) wherein the structured protein product comprises from about 35% to about 65% soy protein on a dry matter basis, from about 20% to about 30% wheat gluten on a dry matter basis; from about 10% to about 15% wheat starch on a dry matter basis; and from about 1% to about 5% fiber on a dry matter basis;
(c) a fat substance in an amount sufficient to meet the daily nutrient requirement of the companion animal; and,
(d) at least one nutrient selected from the group consisting go vitamins and minerals in an amount sufficient to meet the daily nutrient requirement of the companion animal.

17. The companion animal food of claim 16, further comprising animal protein.

18. The companion animal food composition of claim 16, wherein the companion animal is selected from the group consisting of a dog and a cat.

19. The companion animal food composition of claim 16, wherein the companion animal food composition is a natural companion animal food composition.

20. An organic companion animal food composition substantially free of meat, the composition comprising:
(a) a structured plant protein product comprising protein fibers that are substantially aligned, the structured plant protein product comprising an extrudate of plant protein material;
(b) a non-meat based fat substance in an amount sufficient to meet the daily nutrient requirement of the companion animal; and
(c) at least one nutrient selected from the group consisting of vitamins and minerals in an amount sufficient to meet the daily nutrient requirement of the companion animal.

21. The organic companion animal food composition of claim 20, further comprising an organic ingredient selected from the group consisting of kamut, brown rice, oats, barley, quinoa, sunflower seed meal, flaxseed meal, garlic, red beets, spinach, carrot, broccoli, blueberries, rosemary, and mixtures thereof.
